(19) United States
(12) Patent Application Publication
(10) Pub. No.: US 2008/0120606 A1
(43) Pub. Date: May 22, 2008

(54) Universal XML translator

(75) Inventors: Winfield Scott Stanley, Tucson, AZ (US); Brent Pearson, San Francisco, CA (US)

Correspondence Address: Lawdex Corporation, Suite 121, 118 S. 5th Ave, Tucson, AZ, 85701, US

(73) Assignee: Lawdex Corporation, Tucson, AZ (US)

(21) Appl. No.: 11/601,603

(22) Filed: Nov. 17, 2006

(51) Int. Cl. G06F 9/45; G06F 17/00

(52) U.S. Cl. 717/136; 717/141; 715/239; 715/236

(57) ABSTRACT

An Extensible Markup Language (XML) translator for bridging electronic data and document transfer between differing legal-system XML standards.

### REFERENCES CITED

### U.S. Patent Documents

U.S. Pat. No. 6,964,053 November, 2005, Ho et al.
U.S. Pat. No. 6,738,975 May, 2004 Yee et al.
U.S. Pat. No. 6,094,688 July, 2000 Mellen-Garnet et al.
U.S. Pat. No. 5,732,270 March, 1998 Foody et al. 709/303.
U.S. Pat. No. 5,854,750 December, 1998 Phillips et al. 364/478.
U.S. Pat. No. 5,870,545 February, 1999 Davis et al. 395/200.
U.S. Pat. No. 5,872,971 February, 1999 Knapman et al. 395/671.

### FIELD OF THE INVENTION

The invention relates to the exchange of data across data field standards as defined through Extensible Markup Language (XML) standards being used for electronic data transfer and electronic filing specific, in part, to the legal, medical, and financial fields.

### BACKGROUND

In order for data to be exchanged electronically between legal systems, hospitals, and insurance companies, standards must be agreed to for the naming of data fields. As courts and law enforcement have converted from paper to electronic data storage, the necessity has grown for having standards by which each field on an electronic form be named. Electronic data flow between a court and a law enforcement agency, for instance, requires agreement on the abbreviations for eye color and the naming of the field for eye color. The names and abbreviations for all data fields must be agreed to in advance for the completed transfer of data between organized data lists. Increasingly, these data lists are named and electronically transferred within an XML schema. Several national and international standards for XML schemas have evolved including, GJXDM (Global Justice XML Data Model), LegalXML 3.0, and 2GEFS (2^{nd} Generation Electronic Filing Specification), and HL7 3.0. Prior art allows for a completed transfer of data within a single XML standard. The development of XML standards have by necessity required the regular convening of governing bodies to agree, in part, on the spelling of each XML abbreviation within the standardized dictionary of terms. The need has grown within the legal, law enforcement, medical, and financial arenas for data transfer across differing standards.

### SUMMARY OF THE INVENTION

The invention here outlined allows for complete data transfer between differing XML standards. The primary embodiment of the invention translates between the differing standards for the naming of data fields within an XML schema. Because state and federal courts, and law-enforcement operations use different nomenclature for the naming of their database data-fields, this invention applies an algorithmic methodology for data-field translation of alternate names for like data-fields.

In one embodiment of the invention, a method of processing and translation is applied as data fields are electronically transmitted to a court through the GJXDM standard, then translated through use of a court database dictionary of data-field names and subjects, and finally deposited to a court's case management system within the protocol of a requisite XML schema. The invention solves for translation for all commonly accepted XML standards. The invention conducts the automated translation of differing terms for identical data-fields.

The inventions systems architecture incorporates migration strategies for new releases of XML and release of LegalXML 3.0, GJXDM, and HL7 standards. The invention functions as a bridge translator between standards able to be upgraded quickly and efficiently to the latest XML standards.

The preferred embodiments of the invention presented here are described in the Figures and Detailed Description. Unless specifically noted, it is intended that the words and phrases in the specification and claims are given the ordinary and accustomed meaning to those of ordinary skill in the applicable arts. If any other special meaning is intended for any word or phrase, the specification will clearly state and define the special meaning.

Likewise, the use of the words “function” or “means” in the Detailed Description is not intended to indicate a desire to invoke the special provisions of 36 U.S.C. 112, Paragraph 6, to define the invention. To the contrary, if the provisions of 35 U.S.C. 112, Paragraph 6. Are sought to be invoked to define the invention, the claims will specifically state the phrases “means for” or “step for” and a function, without also reciting in such phrases any structure, material or act in support of the function. Even when the claims recite a “means for” or “step for” performing a function, if they also recite any structure, materials or acts in support of that means or step, then the intention is not to invoke the provisions of 35 U.S.C. 112, Paragraph 6. Moreover, even if the provisions of 35 U.S.C. 112, Paragraph 6 are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, material or acts for performing the claimed function.

### BRIEF DESCRIPTION OF THE DRAWING(S)

FIG. 1, shows a data flow representation across jurisdiction between competing XML standards used in California and Arizona.

FIG. 2, shows a generalized system diagram depicting multiple systems using various standards routing data through the XML translator and capable of sending data to any other system by incorporating the Universal XML Translator.

FIG. 3, shows a sample transaction of a single XML data element. The data element comes into the translator in one standard, is processed through the translator, then continues in the format of the second standard. It shows a translational equivalency match made between two like-fields with differing identifiers.

### DETAILED DESCRIPTION OF THE INVENTION

In one embodiment, the invention conducts translation between Legal XML 3.0, Global Justice XML Data Model (GJXDM), as supported by COSCA/NACM standards and has the flexibility to adapt to emerging Legal XML, GJXDM, and COSCA/NACM standards as well such as Health Level Seven Clinical Document Architecture XML (HL7 CDA, Version 2.3.1).

In one embodiment it is also conceived as a systems schema translator based on Legal XML 3.0 and is compatible with Legal XML Court Filing 1.0, and California 2GEFS Court Filing 2.0. As emerging standards such as GJXDM and Legal XML 3.0 are finalized, the Universal XML Translator, here in described, will allow users to readily adapt to updated or emerging standards, as well as retrieve data as referenced against older XML standardized versions.

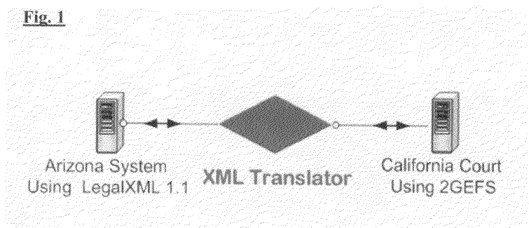

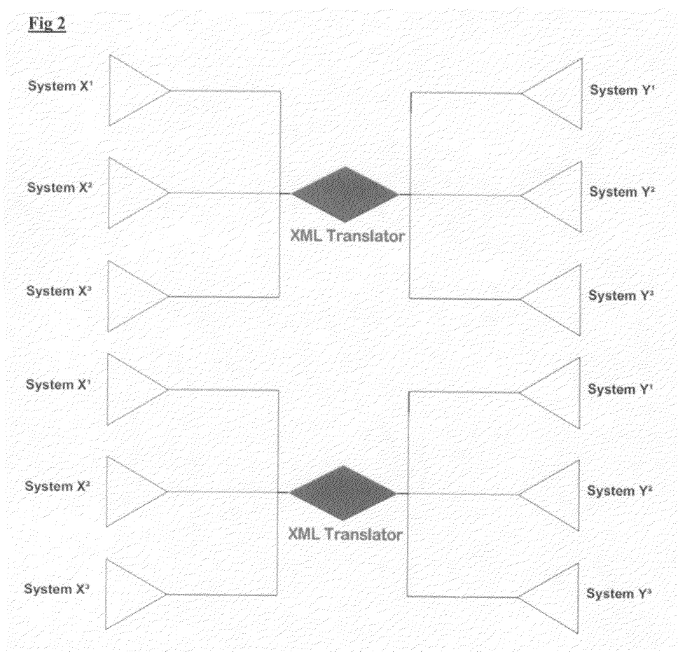

In one embodiment, dataflow (FIG. 1) passes through the translator between competing XML standards. An XML schema generated within a Legal XML 3.0 standard is translated for reading within a 2GEFS standard by reassigning the data-field identifiers appropriate to that standard. The translator does this by making direct comparison of field identifiers across each standard. A database of field identifies is maintained for each standard. Accurate names are then reassigned to each required field based on like-field requirements. The translator references xml-standards databases, cross referencing these database to identify alternately named like-fields (FIG. 2).

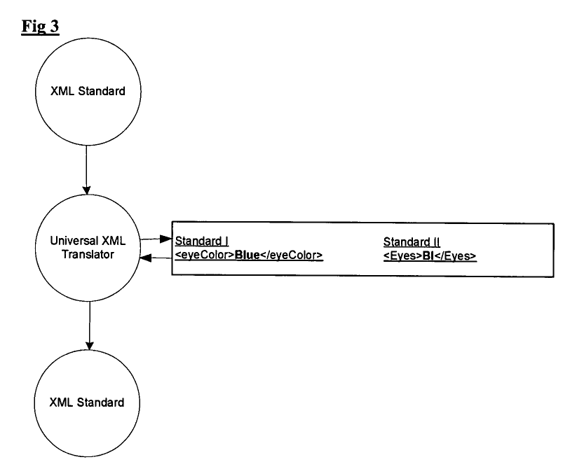

Using comparative databases, field name identifiers are reassigned based on translational equivalency. (FIG. 3)

Having now provided a detailed description of the present invention, it should now be apparent to those skilled in this art that the forgoing is illustrative but not limiting, having been presented by way of example only. Numerous embodiments, other than those illustrated here as means of example, and modifications thereof are contemplated as falling within the scope of the present invention and as defined by the appended claims and equivalents thereto.

1. A method of processing an xml schema comprising:
a) receipt in a first xml-standard
b) field-name translation of equivalent field subjects
c) redefinition of field names into a second xml standard
d) a comparative database
e) converting the response to the application request from the second language received within the application server as the source language to the first language of the first end user application as the target language, each comprising the steps by invoking Type Descriptor class connector metamodels having metamodel metadata of respective source and target languages, said Type Descriptor class connector metamodels comprising an Instance Type Descriptor Base class, a Type Descriptor Language Element class, and a Language Element Model inheriting from the type Description Language Element class;
f) populating the Type Descriptor class connector metamodels with metamodel data Language Elements of each of the respective source and target languages; and
g) converting the source language to the target language

2. The method of claim 1 wherein the end-user application is a web browser.

3. The method of claim 1 wherein the metamodel met data further comprises invocation metamodel metadata, application domain interface metamodel metadata, and Type Descriptor metamodel metadata.
a. The method of claim 3 wherein the invocation metamodel metadata is chosen from the group consisting of XML message control information, pre-condition and post-condition resources, and user data.
b. The method of claim 3 wherein the application domain interface metamodel metadata comprises input parameter signatures, output parameter signatures, and return types.
c. The method of claim 3 wherein the application domain interface metamodel metadata further includes language metamodel metadata.
d. The method of claim 3 wherein the source language metamodel metadata maps encapsulated objects into code and data.
e. The method of claim 3 wherein the language metamodel metadata maps object inheritances into references and pointers.
f. The method of claim 3 wherein the Type Descriptor metamodel metadata associates physical realizations and storage mappings, to data types, data structures, and realization constraints.
g. The method of claim 1 consisting of database reliant translational processing system comprising a database, a server, and at least one connector there between.
